(19) United States
(12) Patent Application Publication
(10) Pub. No.: US 2026/0230953 A1
(43) Pub. Date: Aug. 6, 2026

(54) ENHANCED INTRA-BAND NON-COLLOCATED CARRIER AGGREGATION

(71) Applicant: APPLE INC., Cupertino, CA (US)

(72) Inventors: Yuexia Song, Beijing (CN); Yang Tang, San Jose, CA (US); Dawei Zhang, Saratoga, CA (US); Qiming Li, Beijing (CN); Jie Cui, San Jose, CA (US); Xiang Chen, Campbell, CA (US); Rolando E Bettancourt Ortega, Munich (DE)

(21) Appl. No.: 19/148,769

(22) PCT Filed: Feb. 17, 2023
(86) PCT No.: PCT/CN2023/076751

§ 371 Date: Jul. 17, 2025

(51) Int. Cl. H04W 36/00; H04B 17/318; H04W 52/02

(52) U.S. Cl. CPC H04W 36/00692; H04B 17/328; H04W 52/0235

(57) ABSTRACT

The present disclosure relates to enhanced intra-band non-collocated carrier aggregation. A network device may be configured to receive, from a wireless device, a capability of supporting a new type of carrier aggregation; and schedule the new type of carrier aggregation for the wireless device based on the received capability, wherein the capability of supporting the new type of carrier aggregation includes: supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four MIMO layers.

### TECHNICAL FIELD

This application relates generally to wireless communication systems, including carrier aggregation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Intra-band co-located carrier aggregation (CA) has been discussed and studied these years. In the scenario of intra-band co-location CA, transmit (Tx) antenna collocation is required to ensure that the component carriers are co-located. However, Tx antenna collocation is sometimes cost-inefficient or infeasible due to spectrum situation of the operation. For example, the spectrum allocation is in a phased manner in the frequency range of 3300~4200 MHz, and there is no room to co-locate the later launched Tx antennas of a base station with a co-located manner with early Tx antennas.

In view of this, intra-band non-collocated CA is under consideration. In the scenario of intra-band non-collocated CA, it is no longer necessary to co-locate the component carriers, and thus Tx antenna collocation is simplified. However, due to the non-collocation, a larger received time difference (RTD) between component carriers to be aggregated, which is a relative receiving time difference between two signals relatively received on the component carriers, may be observed. Further, a power imbalance between component carriers to be aggregated may be large. Therefore, a new type of scheduling and reporting policy needs to be considered for an enhanced support of intra-band non-collocated CA.

A wireless device according to some embodiments of the present disclosure may be configured to report, to a network device, a capability of supporting a new type of carrier aggregation; measure a Received Time Difference (RTD) between a first component carrier and a second component carrier, wherein the first component carrier is a serving component carrier of the wireless device, and the second component carrier is indicated by the network device as a component carrier to be aggregated with the first component carrier, and wherein the RTD is a relative receiving time difference between two signals relatively received on the first component carrier and the second component carrier; and report, to the network device, the measured RTD between the first component carrier and the second component carrier for the network device to schedule the new type of carrier aggregation. The capability of supporting the new type of carrier aggregation may include supporting a maximum RTD between aggregated component carriers that is no less than a predetermined RTD threshold; supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four Multiple-Input Multiple-Output (MIMO) layers.

A network device according to some embodiments of the present disclosure may be configured to receive, from a wireless device, a capability of supporting a new type of carrier aggregation; and schedule the new type of carrier aggregation for the wireless device based on the received capability. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four MIMO layers.

A wireless device according to some embodiments of the present disclosure may be configured to report, to a network device, a capability of supporting a new type of carrier aggregation; measure a first Reference Signal Receiving Power (RSRP) for a first component carrier and a second RSRP for a second component carrier, wherein the first component carrier is a serving component carrier of the wireless device, and the second component carrier is indicated by the network device as a component carrier to be aggregated with the first component carrier; and report, to the network device, a power imbalance between the first component carrier and the second component carrier determined from the first RSRP and the second RSRP for the network device to schedule the new type of carrier aggregation. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold; and at least one component carrier supports a maximum of four MIMO layers.

A network device according to some embodiments of the present disclosure may be configured to receive, from a wireless device, a capability of supporting a new type of carrier aggregation; and schedule the new type of carrier aggregation for the wireless device based on the received capability. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold; and at least one component carrier supports a maximum of four MIMO layers.

A method for a wireless device according to some embodiments of the present disclosure may comprise reporting, to a network device, a capability of supporting a new type of carrier aggregation; measuring an RTD between a first component carrier and a second component carrier, wherein the first component carrier is a serving component carrier of the wireless device, and the second component carrier is indicated by the network device as a component carrier to be aggregated with the first component carrier, and wherein the RTD is a relative receiving time difference between two signals relatively received on the first component carrier and the second component carrier; and reporting, to the network device, the measured RTD between the first component carrier and the second component carrier for the network device to schedule the new type of carrier aggregation. The capability of supporting the new type of carrier aggregation may include supporting a maximum RTD between aggregated component carriers that is no less than a predetermined RTD threshold; supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four MIMO layers.

A method for a network device according to some embodiments of the present disclosure may comprise receiving, from a wireless device, a capability of supporting a new type of carrier aggregation; and scheduling the new type of carrier aggregation for the wireless device based on the received capability. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four MIMO layers.

A method for a wireless device according to some embodiments of the present disclosure may comprise reporting, to a network device, a capability of supporting a new type of carrier aggregation; measuring a first RSRP for a first component carrier and a second RSRP for a second component carrier, wherein the first component carrier is a serving component carrier of the wireless device, and the second component carrier is indicated by the network device as a component carrier to be aggregated with the first component carrier; and reporting, to the network device, a power imbalance between the first component carrier and the second component carrier represented by the first RSRP and the second RSRP for the network device to schedule the new type of carrier aggregation. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold; and at least one component carrier supports a maximum of four MIMO layers.

A method for a network device according to some embodiments of the present disclosure may comprise receiving, from a wireless device, a capability of supporting a new type of carrier aggregation; and scheduling the new type of carrier aggregation for the wireless device based on the received capability. The capability of supporting the new type of carrier aggregation may include supporting a maximum RTD between aggregated component carriers that is no less than a predetermined RTD threshold, wherein the RTD is a relative receiving time difference between two signals relatively received on the aggregated component carriers; supporting a maximum power imbalance between aggregated component carriers that is no less than a predetermined power imbalance threshold; and at least one component carrier supports a maximum of four MIMO layers.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example method for a wireless device which reports a capability of supporting a new type of CA according to some embodiments disclosed herein.

FIG. 4 illustrates an example method for a network device which schedules the new type of CA according to some embodiments disclosed herein.

FIG. 5 illustrates an example signaling diagram between the network device and the wireless device for the new type of CA according to some embodiments disclosed herein.

FIG. 6 illustrates another example method for a wireless device which reports a capability of supporting a new type of CA according to some embodiments disclosed herein.

FIG. 7 illustrates another example method for a network device which schedules the new type of CA according to some embodiments disclosed herein.

FIG. 8 illustrates another example signaling diagram between the network device and the wireless device for the new type of CA according to some embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

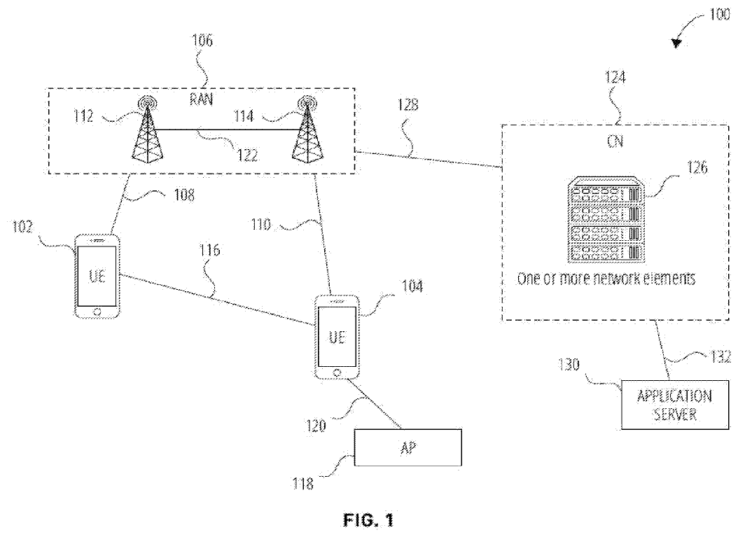

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications or uplink communication or ProSe or sidelink communication) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services).

The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

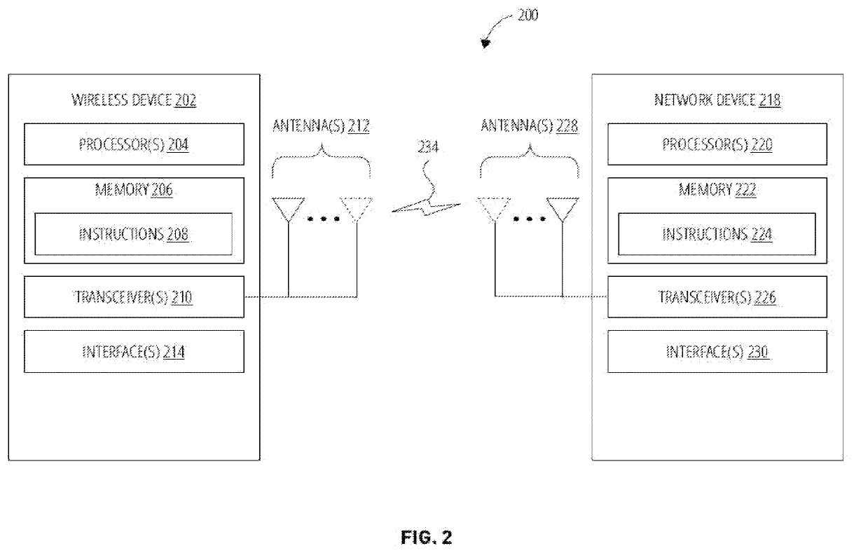

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

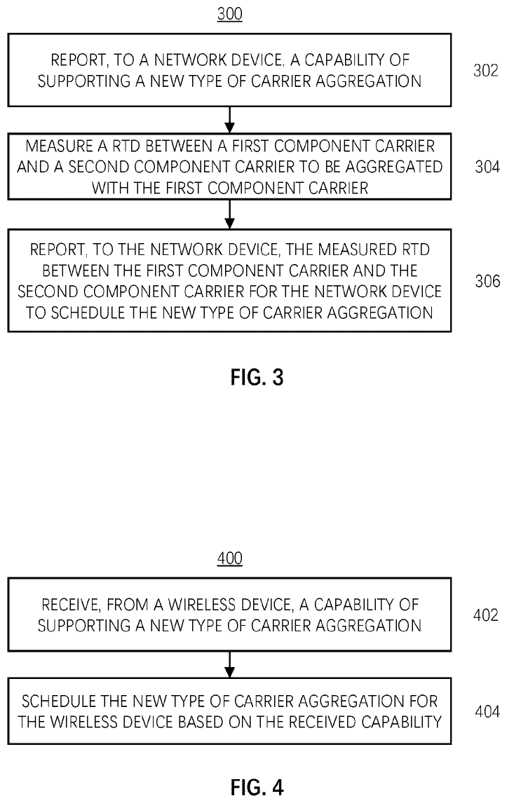

Now refer to FIGS. 3-8, exemplary embodiments of a new type of scheduling and reporting policy of a wireless device and a network device for an enhanced support of intra-band non-collocated CA will be described.

As mentioned above, for intra-band non-collocated CA, due to the non-collocation, a larger RTD between component carriers to be aggregated may be observed. Further, a power imbalance between component carriers to be aggregated may be large. These two parameters are essential in the scenario of intra-band non-collocated CA, and if a UE cannot support the RTD and/or the power balance, the non-collocated CA may not be guaranteed even it is scheduled by the network device.

Therefore, when performing CA scheduling, the network device needs to know the capability of the UE indicating whether the UE can support a carrier aggregation with a certain RTD and/or a certain level of power imbalance. Accordingly, the UE needs to report its capability to the network device to facilitate the CA scheduling.

In the description below, FIGS. 3-5 describe the RTD-based scheduling and reporting, and FIGS. 6-8 describe the power imbalance-based scheduling and reporting.

Now refer to FIG. 3, an example method 300 for a wireless device which reports a capability of supporting the new type of CA according to some embodiments disclosed herein will be described.

In 302, the network device reports, to a network device, a capability of supporting a new type of CA. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In this disclosure, the “new” type of CA means a newly designed type of CA according to some embodiments disclosed herein compared to any legacy type of CA. Further, it is noted that the wording “legacy” described herein means any existing scheme before the present disclosure, including but not limited to any scheme related to the LTE system standards and/or 5G or NR system standards as provided by 3GPP technical specifications.

For example, the legacy type of CA may indicate a type 1 CA where the UE supports a maximum RTD (MRTD) ≤3 μs and supports 6 dB power imbalance. The RTD may be a relative receiving time difference between two signals relatively received on the aggregated component carriers. Further, the power imbalance may indicate a difference of receiving power between two signals relatively received on the aggregated component carriers.

The type 1 CA is mainly used for intra-band co-located CA. Since the supportable MRTD and power imbalance are relatively small for the type 1 CA, and may not be available for intra-band non-collocated CA scenarios, the new type of intra-band non-collocated CA is needed.

In some embodiments, the capability of supporting the new type of carrier aggregation may include: supporting a maximum RTD between aggregated component carriers that is no less than a predetermined RTD threshold; supporting a maximum power imbalance between aggregated component carriers that is no less than a predetermined power imbalance threshold; and at least one component carrier supports a maximum of four MIMO layers.

The predetermined RTD threshold and the predetermined power imbalance threshold may be properly determined based on practical network requirements. For example, the predetermined RTD threshold may be equal to a Cyclic Prefix (CP) length of an OFDM symbol, or any other value larger than the MRTD of type 1 CA. For example, the predetermined power imbalance threshold may be 15 dB, or any other value larger than the maximum 6 dB power imbalance of type 1 CA. The predetermined RTD threshold and/or the predetermined power imbalance may be configured by the network device according to the network environment, or may be specified in 3GPP technical specifications.

In 304, the wireless device measures the RTD between a first component carrier and a second component carrier. The first component carrier is a serving component carrier (e.g., the primary cell frequency) of the wireless device, and the second component carrier is indicated by the network device as a component carrier to be aggregated with the first component carrier. For example, the wireless device may receive a measurement object (MO) from the network device in which the second component carrier is indicated. Further, the RTD is a relative receiving time difference between two signals relatively received on the first component carrier and the second component carrier.

In 306, the wireless device reports, to the network device, the measured RTD between the first component carrier and the second component carrier for the network device to schedule the new type of carrier aggregation.

FIG. 4 illustrates an example method 400 for a network device which schedules the new type of CA according to some embodiments disclosed herein will be described.

In 402, the network device receives, from a wireless device, a capability of supporting a new type of carrier aggregation. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In some embodiments, the capability of supporting the new type of carrier aggregation may include: supporting a maximum RTD between aggregated component carriers that is no less than a predetermined RTD threshold; supporting a maximum power imbalance between aggregated component carriers that is no less than a predetermined power imbalance threshold; and at least one component carrier supports a maximum of four MIMO layers. For example, the network device may receive the report including the capability which is reported in 302 of method 300 in FIG. 3 by the wireless device.

In 404, the network device schedules the new type of carrier aggregation for the wireless device based on the received capability.

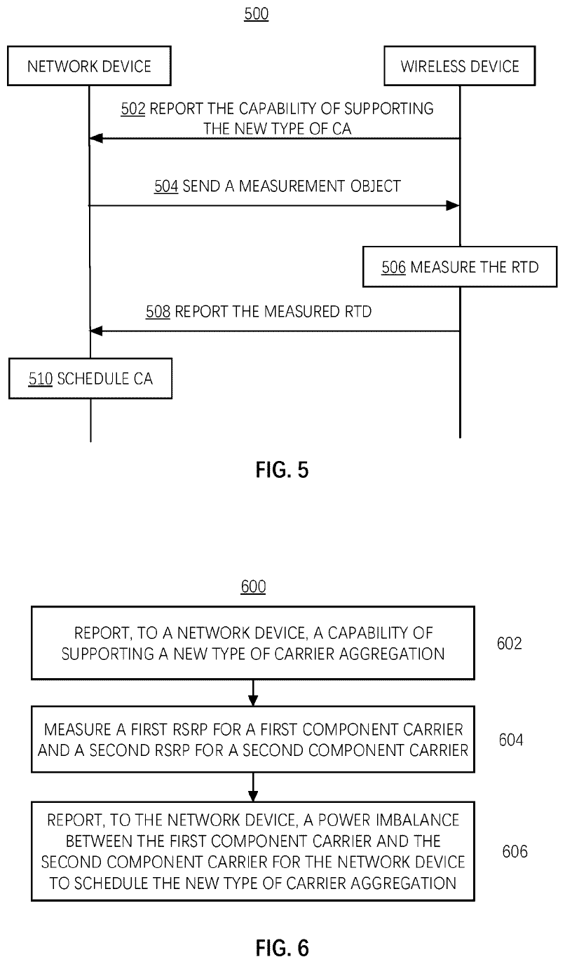

The detailed scheduling and reporting of the new type of CA will be further described with reference to an example signaling diagram 500 between the network device and the wireless device shown in FIG. 5.

In 502, the wireless device reports to the network device the capability of supporting the new type of CA. This step may correspond to 302 in method 300. Further, the network receives the report from the wireless device, which may correspond to 402 in method 400.

In 504, the network device sends to the wireless device an MO which indicates a non-collocated frequency to be aggregated with the serving frequency of the wireless device. The non-collocated frequency may correspond to the second component carrier described above, and the serving frequency may correspond to the first component carrier described above. It is noted that the network device may indicate the non-collocated frequency to the wireless device through other means instead of the MO.

In 506, the wireless device measures the RTD between the first component carrier and the second component carrier, wherein the second component carrier is indicated by the MO sent by the network device in 504. This step may correspond to 304 in method 300.

In 508, the wireless device reports the measured RTD to the network device. This step may correspond to 306 in method 300.

In 510, the network device performs CA scheduling based on the measured RTD. This step may correspond to 404 in method 400.

In some embodiments, in 510, in response to determining that the measured RTD is no less than the predetermined RTD threshold of the new type of CA, which means that the new type of CA is available based on the current network environment, the network device schedules the new type of CA. In some embodiments, the scheduling of the new type of CA may include activating the non-collocated component carrier (e.g., the second component carrier) and scheduling four MIMO layers on the component carrier. In some embodiments, if the new type of CA supports four MIMO layers for each component carrier, the network device may schedule four MIMO layers on each component carrier.

In some embodiments, in 510, in response to determining that the measured RTD is larger than the predetermined RTD threshold of the new type of CA, which means that the new type of CA is not available based on the current network environment, the network device will not schedule the new type of CA.

Accordingly, the network device may determine whether to schedule the new type of CA based on the RTD-related capability of the wireless device and the current network environment.

Further, in some embodiments, in 508, instead of reporting the measured RTD, the wireless device may only report to the network that whether the measured RTD is larger than the predetermined RTD threshold or not, so as to save signaling overhead.

In some embodiments, in addition to reporting of the capability of supporting the new type of CA in 502, the wireless device may further report to the network device a capability of compatibility with a legacy type of carrier aggregation. For example, for the legacy type of carrier aggregation, a supportable maximum RTD between aggregated component carriers may be no less than 33 μs, a supportable maximum power imbalance between aggregated component carriers is no less than 25 dB, and at least one component carrier supports a maximum of two MIMO layers. This legacy type of CA is also used for intra-band non-collocated CA, and may be referred to as a type 2 CA. Further, the new type of CA according to some embodiments described herein may be referred to as a type 3 CA.

It is noted that the legacy type of CA described above, i.e., the type 2 CA, is an example, and the wireless device supporting the new type of CA (e.g., the type 3 CA) may be compatible with other legacy types of intra-band non-collocated CA, or even the above-described type 1 intra-band collocated CA. Further, it is noted that the predetermined RTD threshold of the type 3 CA may be equal to, less than or larger than the supportable maximum RTD of 33 μs of the type 2 CA.

The report of the capability of compatibility may be performed before, after or at the same time with 502 in which the capability of supporting the type 3 CA is reported.

In some embodiments, in 510, in response to determining that the measured RTD is larger than the predetermined RTD threshold of the type 3 CA while the capability of compatibility with the legacy type of CA is reported, the network device may schedule the legacy type of CA. For example, the network device may activate the non-collocated component carrier of type 2 CA and schedule two MIMO layers on the component carrier. Accordingly, in 510, the scheduling may be performed for type 3 CA or fallback to a legacy type of CA (e.g., type 2 CA) based on different network environments. Therefore, the scheduling may be flexibly changed according to the network environment.

As described above, in 510, the network device may perform CA scheduling based on the measured RTD from the wireless device. However, in some other embodiments, the network device may perform CA scheduling based on a maximum RTD instead of the measured RTD from the wireless device.

Specifically, in some embodiments, the network device may determine a maximum RTD based on a network deployment related to the network device. The determination of the maximum RTD may be performed by the network device by any existing methods. For example, the maximum RTD may be determined based on history reports of measured RTDs of a plurality of wireless devices within the network environment, or determined based on other parameters of the network deployment. The network device may schedule the new type of CA in response to determining that the maximum RTD is no less than the predetermined RTD threshold. In this case, the measurement of RTD in 506 and the report of the measured RTD in 508 at the wireless device may be omitted.

The above-described embodiments may be suitably applied to a new radio (NR) network architecture. In addition, for a dual connectivity network architecture in which a legacy network (e.g., LTE) and an NR is connected, the capability of supporting the new type of carrier aggregation may include: at least one component carrier for the legacy network supports a maximum of two MIMO layers and at least one component carrier for the NR supports a maximum of four MIMO layers. Further, scheduling the new type of carrier aggregation may include scheduling two MIMO layers on the at least one component carrier for the legacy network and scheduling four MIMO layers on the at least one component carrier for the NR. In the case of the dual connectivity, the first component carrier may correspond to the component carrier for the legacy network, and the second component carrier may correspond to the component carrier for the NR. Further, the dual connectivity may include but not limited to an EN-DC (Evolved Universal Terrestrial Radio Access (E-UTRA)-NR Dual Connectivity).

The above FIGS. 3-5 described the RTD-based scheduling and reporting according to some embodiments disclosed herein. Next, FIGS. 6-8 will be referred to describe the power imbalance-based scheduling and reporting according to some embodiments disclosed herein.

Now refer to FIG. 6, an example method 600 for a wireless device which reports capability of supporting the new type of CA according to some embodiments disclosed herein will be described.

In 602, the network device reports, to a network device, a capability of supporting a new type of CA. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In some embodiments, the capability of supporting the new type of carrier aggregation may include: supporting a maximum RTD between aggregated component carriers that is no less than a predetermined RTD threshold; supporting a maximum power imbalance between aggregated component carriers that is no less than a predetermined power imbalance threshold; and at least one component carrier supports a maximum of four MIMO layers.

The power imbalance may indicate a difference of receiving power between two signals relatively received on the aggregated component carriers. The predetermined RTD threshold and the predetermined power imbalance threshold may be properly determined based on practical network requirements. For example, the predetermined power imbalance threshold may be 15 dB, or any other value larger than the maximum 6 dB power imbalance of type 1CA. For example, the predetermined power imbalance threshold may be 15 dB, or any other value larger than the maximum 6 dB power imbalance of type 1 CA. The predetermined RTD threshold and/or the predetermined power imbalance threshold may be configured by the network device according to the network environment, or may be specified in 3GPP technical specifications.

In 604, the wireless device measures a first Reference Signal Receiving Power (RSRP) for a first component carrier and a second RSRP for a second component carrier. The first component carrier is a serving component carrier (e.g., the primary cell frequency) of the wireless device, and the second component carrier is indicated by the network device as a component carrier to be aggregated with the first component carrier. For example, the wireless device may receive an MO from the network device in which the second component carrier is indicated.

In 606, the wireless device reports, to the network device, a power imbalance between the first component carrier and the second component carrier determined from the first RSRP and the second RSRP for the network device to schedule the new type of carrier aggregation. It is noted that the RSRP is an example for determining the power imbalance between two aggregated component carriers, and other power-related parameter(s) may be used for determining the power imbalance.

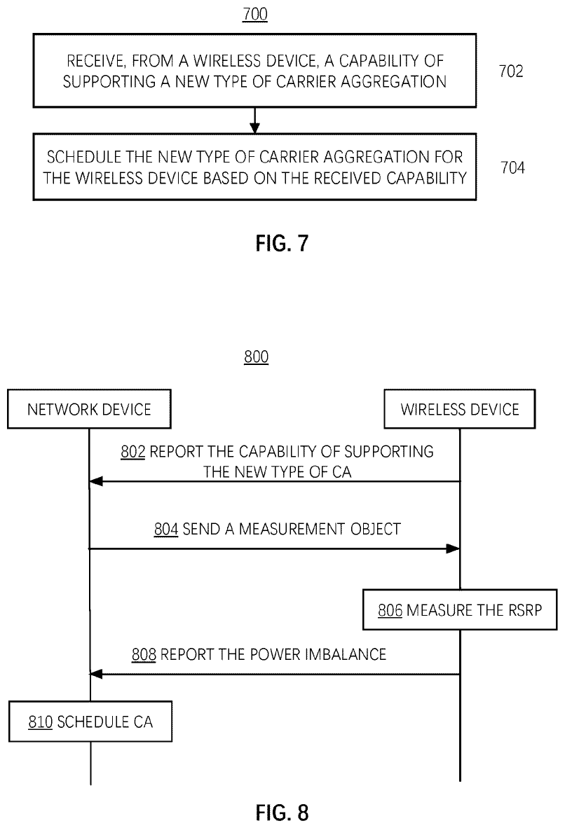

FIG. 7 illustrates an example method 700 for a network device which schedules the new type of CA according to some embodiments disclosed herein will be described.

In 702, the network device receives, from a wireless device, a capability of supporting a new type of carrier aggregation. The network device may correspond to any of base stations 112, 114 described in FIG. 1 or the network device 218 described in FIG. 2. The wireless device may correspond to any of UEs 102, 104 described in FIG. 1 or the wireless device 202 described in FIG. 2.

In some embodiments, the capability of supporting the new type of carrier aggregation may include: supporting a maximum RTD between aggregated component carriers that is no less than a predetermined RTD threshold; supporting a maximum power imbalance between aggregated component carriers that is no less than a predetermined power imbalance threshold; and at least one component carrier supports a maximum of four MIMO layers. For example, the network device may receive the report including the capability which is reported in 602 of method 600 in FIG. 6 by the wireless device.

In 704, the network device schedules the new type of carrier aggregation for the wireless device based on the received capability.

The detailed scheduling and reporting of the new type of CA will be further described with reference to an example signaling diagram 800 between the network device and the wireless device shown in FIG. 8.

In 802, the wireless device reports to the network device the capability of supporting the new type of CA. This step may correspond to 602 in method 600. Further, the network receives the report from the wireless device, which may correspond to 702 in method 700.

In 804, the network device sends to the wireless device an MO which indicates a non-collocated frequency to be aggregated with the serving frequency of the wireless device. The non-collocated frequency may correspond to the second component carrier described above, and the serving frequency may correspond to the first component carrier described above. It is noted that the network device may indicate the non-collocated frequency to the wireless device through other means instead of the MO.

In 806, the wireless device measures the first RSRP for the first component carrier and the second RSRP for the second component carrier, wherein the second component carrier is indicated by the MO sent by the network device in 804. This step may correspond to 604 in method 600.

In 808, the wireless device reports, to the network device, the power imbalance between the first component carrier and the second component carrier determined from the first RSRP and the second RSRP. This step may correspond to 606 in method 600.

In 810, the network device performs CA scheduling based on the reported power imbalance. This step may correspond to 704 in method 700.

In some embodiments, in 810, in response to determining that the power imbalance is no less than the predetermined power imbalance threshold of the new type of CA, which means that the new type of CA is available based on the current network environment, the network device schedules the new type of CA. In some embodiments, the scheduling of the new type of CA may include activating the non-collocated component carrier (e.g., the second component carrier) and scheduling four MIMO layers on the component carrier. In some embodiments, if the new type of CA supports four MIMO layers for each component carrier, the network device may schedule four MIMO layers on each component carrier.

In some embodiments, in 810, in response to determining that the power imbalance is larger than the predetermined power imbalance threshold of the new type of CA, which means that the new type of CA is not available based on the current network environment, the network device will not schedule the new type of CA.

Accordingly, the network device may determine whether to schedule the new type of CA based on the power imbalance-related capability of the wireless device and the current network environment.

In some embodiments, in 808, the power imbalance may be determined from a differential RSRP value between the first RSRP and the second RSRP. For example, the differential RSRP value may be reported from the wireless device to the network device as the power imbalance.

In some embodiments, in 808, instead of reporting the power imbalance, the wireless device may only report to the network that whether the power imbalance is larger than the predetermined power imbalance threshold or not, so as to save signaling overhead.

In some other embodiments, in 806, the wireless device may measure a plurality RSRPs for a plurality of available component carriers including the first component carrier and the second component carrier. Further, in 808, the wireless device may report, to the network device, a maximum RSRP among the plurality of RSRPs and differential RSRP values between the maximum RSRP and other RSRPs of the plurality of RSRPs. Accordingly, the network device may determine the power imbalance between the first component carrier and the second component carrier from the maximum RSRP and the differential RSRP values.

In some embodiments, in addition to reporting of the capability of supporting the new type of CA in 802, the wireless device may further report to the network device a capability of compatibility with a legacy type of carrier aggregation. For example, for the legacy type of carrier aggregation, a supportable maximum RTD between aggregated component carriers is no less than 33 μs, a supportable power imbalance between aggregated component carriers is no less than 25 dB, and at least one component carrier supports a maximum of two MIMO layers. This legacy type of CA may be the above-described type 2 CA. Further, the new type of CA may be the above-described type 3 CA.

It is noted that the legacy type of CA described above, i.e., the type 2 CA, is an example, and the wireless device supporting the new type of CA (e.g., the type 3 CA) may be compatible with other legacy types of intra-band non-collocated CA, or even the above-described type 1 intra-band collocated CA. Further, it is noted that the predetermined power imbalance threshold of the type 3 CA may be equal to, less than or larger than the maximum supportable power imbalance of 25 dB of the type 2 CA.

The report of the capability of compatibility may be performed before, after or at the same time with 802 in which the capability of supporting the type 3 CA is reported.

In some embodiments, in 810, in response to determining that the power imbalance is larger than the predetermined power imbalance threshold of the type 3 CA while the capability of compatibility with the legacy type of CA is reported, the network device may schedule the legacy type of CA. For example, the network device may activate the non-collocated component carrier of type 2 CA and schedule two MIMO layers on the component carrier.

Accordingly, in 810, the scheduling may be performed for type 3 CA or fallback to a legacy type of CA (e.g., type 2 CA) based on different network environments. Therefore, the scheduling may be flexibly changed according to the network environment.

As described above, in 810, the network device may perform CA scheduling based on the power imbalance from the wireless device. However, in some other embodiments, the network device may perform CA scheduling based on a maximum power imbalance instead of the reported power imbalance from the wireless device.

Specifically, in some embodiments, the network device may determine a maximum power imbalance based on a network deployment related to the network device. The determination of the maximum power imbalance may be performed by the network device by any existing methods. For example, the maximum power imbalance may be determined based on history report of power imbalance of a plurality of wireless devices within the network environment, or determined based on other parameters of the network deployment. The network may schedule the new type of CA in response to determining that the maximum power imbalance is no less than the predetermined power imbalance threshold. In this case, the measurement of power imbalance in 806 and the report of the power imbalance in 808 at the wireless device may be omitted.

The above-described embodiments may be suitably applied to a new radio (NR) network architecture. In addition, for a dual connectivity network architecture in which a legacy network (e.g., LTE) and an NR is connected, the capability of supporting the new type of carrier aggregation may include: at least one component carrier for the legacy network supports a maximum of two MIMO layers and at least one component carrier for the NR supports a maximum of four MIMO layers. Further, scheduling the new type of carrier aggregation may include scheduling two MIMO layers on the at least one component carrier for the legacy network and scheduling four MIMO layers on the at least one component carrier for the NR. In the case of the dual connectivity, the first component carrier may correspond to the component carrier for the legacy network, and the second component carrier may correspond to the component carrier for the NR. Further, the dual connectivity may include but not limited to an EN-DC (Evolved Universal Terrestrial Radio Access (E-UTRA)-NR Dual Connectivity).

Embodiments contemplated herein include an apparatus comprising means to perform one or more elements of the methods illustrated in FIGS. 3, 4, 6 and 7, or one or more elements of the signaling illustrated in FIGS. 5 and 8. This apparatus may be, for example, an apparatus of a base station (such as a network device 218 that is a base station, as described herein) or an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the methods illustrated in FIGS. 3, 4, 6 and 7, or one or more elements of the signaling illustrated in FIGS. 5 and 8. This non-transitory computer-readable media may be, for example, a memory of a base station (such as a memory 222 of a network device 218 that is a base station, as described herein) or a memory of a UE (such as a memory 206 of a wireless device 202 that is a UE, as described herein).

Embodiments contemplated herein include an apparatus comprising logic, modules, or circuitry to perform one or more elements of the methods illustrated in FIGS. 3, 4, 6, 7, or one or more elements of the signaling illustrated in FIGS. 5 and 8. This apparatus may be, for example, an apparatus of a base station (such as a network device 218 that is a base station, as described herein) or an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the methods illustrated in FIGS. 3, 4, 6 and 7, or one or more elements of the signaling illustrated in FIGS. 5 and 8. This apparatus may be, for example, an apparatus of a base station (such as a network device 218 that is a base station, as described herein) or an apparatus of a UE (such as a wireless device 202 that is a UE, as described herein).

Embodiments contemplated herein include a signal as described in or related to one or more elements of the methods illustrated in FIGS. 3, 4, 6 and 7, or one or more elements of the signaling illustrated in FIGS. 5 and 8.

Embodiments contemplated herein include a computer program or computer program product comprising instructions, wherein execution of the program by a processing element is to cause the processing element to carry out one or more elements of the methods illustrated in FIGS. 3, 4, 6 and 7, or one or more elements of the signaling illustrated in FIGS. 5 and 8. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein). The processor may be a processor of a UE (such as a processor(s) 204 of a wireless device 202 that is a UE, as described herein).

These instructions may be, for example, located in the processor and/or on a memory of the UE (such as a memory 206 of a wireless device 202 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
a memory, in which instructions are stored; and
at least one processor, configured to execute the instructions stored in the memory to cause the wireless device to:
report, to a network device, a capability of supporting a new type of carrier aggregation;
measure a Received Time Difference (RTD) between a first component carrier and a second component carrier, wherein the first component carrier is a serving component carrier of the wireless device, and the second component carrier is indicated by the network device as a component carrier to be aggregated with the first component carrier, and wherein the RTD is a relative receiving time difference between two signals relatively received on the first component carrier and the second component carrier; and
report, to the network device, the measured RTD between the first component carrier and the second component carrier for the network device to schedule the new type of carrier aggregation, wherein the capability of supporting the new type of carrier aggregation includes:
supporting a maximum RTD between aggregated component carriers that is no less than a predetermined RTD threshold;
supporting a maximum power imbalance between aggregated component carriers that is no less than a predetermined power imbalance threshold, wherein the power imbalance indicates a difference of receiving power between two signals relatively received on the aggregated component carriers; and at least one component carrier supports a maximum of four Multiple-Input Multiple-Output (MIMO) layers.

2. The wireless device of claim 1, wherein the at least one processor is further configured to execute the instructions stored in the memory to cause the wireless device to:
report, to the network device, a capability of compatibility with a legacy type of carrier aggregation.

3. The wireless device of claim 2, wherein for the legacy type of carrier aggregation, a supportable maximum RTD between aggregated component carriers is no less than 33 μs, a supportable maximum power imbalance between aggregated component carriers is no less than 25 dB, and at least one component carrier supports a maximum of two MIMO layers.

4. The wireless device of claim 1, wherein for a dual connectivity network architecture of a legacy network and a new radio (NR), the capability of supporting the new type of carrier aggregation includes: at least one component carrier for the legacy network supports a maximum of two MIMO layers and at least one component carrier for the NR supports a maximum of four MIMO layers.

5. The wireless device of claim 4, wherein for the dual connectivity network architecture, the first component carrier is the component carrier for the legacy network and the second component carrier is the component carrier for the NR.

6. A network device, comprising:
a memory, in which instructions are stored; and
at least one processor, configured to execute the instructions stored in the memory to cause the network device to:
receive, from a wireless device, a capability of supporting a new type of carrier aggregation; and
schedule the new type of carrier aggregation for the wireless device based on the received capability, wherein the capability of supporting the new type of carrier aggregation includes:
supporting a maximum RTD between aggregated component carriers that is no less than a predetermined RTD threshold, wherein the RTD is a relative receiving time difference between two signals relatively received on the aggregated component carriers;
supporting a maximum power imbalance between aggregated component carriers that is no less than a predetermined power imbalance threshold, wherein the power imbalance indicates a difference of receiving power between two signals relatively received on the aggregated component carriers; and
at least one component carrier supports a maximum of four MIMO layers.

7. The network device of claim 6, wherein the at least one processor is further configured to execute the instructions stored in the memory to cause the network device to:
determine a maximum RTD based on a network deployment related to the network device; and
schedule the new type of carrier aggregation in response to determining that the maximum RTD is no less than the predetermined RTD threshold.

8. The network device of claim 6, wherein the at least one processor is further configured to execute the instructions stored in the memory to cause the network device to:
receive, from the wireless device, a measured RTD between a first component carrier and a second component carrier, wherein the first component carrier is a serving component carrier of the wireless device, and the second component carrier is indicated by the network device as a component carrier to be aggregated with the first component carrier; and
schedule the new type of carrier aggregation in response to determining that the measured RTD is no less than the predetermined RTD threshold.

9. The network device of claim 8, wherein the at least one processor is further configured to execute the instructions stored in the memory to cause the network device to:
receive, from the wireless device, a capability of compatibility with a legacy type of carrier aggregation; and
schedule the legacy type of carrier aggregation for the wireless device in response to determining that the measured RTD is larger than the predetermined RTD threshold.

10. The network device of claim 9, wherein for the legacy type of carrier aggregation, a supportable maximum RTD between aggregated component carriers is no less than 33 μs, a supportable power imbalance between aggregated component carriers is no less than 25 dB, and at least one component carrier supports a maximum of two MIMO layers.

11. The network device of claim 6, wherein scheduling the new type of carrier aggregation includes scheduling four MIMO layers on the at least one component carrier.

12. The network device of claim 6, wherein for a dual connectivity network architecture of a legacy network and an NR, the capability of supporting the new type of carrier aggregation includes: at least one component carrier for the legacy network supports a maximum of two MIMO layers and at least one component carrier for the NR supports a maximum of four MIMO layers.

13. The network device of claim 12, wherein for the dual connectivity network architecture, scheduling the new type of carrier aggregation includes scheduling two MIMO layers on the at least one component carrier for the legacy network and scheduling four MIMO layers on the at least one component carrier for the NR.

14. A wireless device, comprising:
a memory, in which instructions are stored; and
at least one processor, configured to execute the instructions stored in the memory to cause the wireless device to:
report, to a network device, a capability of supporting a new type of carrier aggregation;
measure a first Reference Signal Receiving Power (RSRP) for a first component carrier and a second RSRP for a second component carrier, wherein the first component carrier is a serving component carrier of the wireless device, and the second component carrier is indicated by the network device as a component carrier to be aggregated with the first component carrier; and
report, to the network device, a power imbalance between the first component carrier and the second component carrier determined from the first RSRP and the second RSRP for the network device to schedule the new type of carrier aggregation, wherein the capability of supporting the new type of carrier aggregation includes:
supporting a maximum RTD between aggregated component carriers that is no less than a predetermined RTD threshold, wherein the RTD is a relative receiving time difference between two signals relatively received on the aggregated component carriers;
supporting a maximum power imbalance between aggregated component carriers that is no less than a predetermined power imbalance threshold; and
at least one component carrier supports a maximum of four MIMO layers.

15. The wireless device of claim 14, wherein the at least one processor is further configured to execute the instructions stored in the memory to cause the wireless device to:
report, to the network device, a capability of compatibility with a legacy type of carrier aggregation.

16. The wireless device of claim 15, wherein for the legacy type of carrier aggregation, a supportable maximum RTD between aggregated component carriers is no less than 33 μs, a supportable maximum power imbalance between aggregated component carriers is no less than 25 dB, and at least one component carrier supports a maximum of two MIMO layers.

17. The wireless device of claim 14, wherein for a dual connectivity network architecture of a legacy network and a new radio (NR), the capability of supporting the new type of carrier aggregation includes: at least one component carrier for the legacy network supports a maximum of two MIMO layers and at least one component carrier for the NR supports a maximum of four MIMO layers.

18. The wireless device of claim 17, wherein for the dual connectivity network architecture, the first component carrier is the component carrier for the legacy network and the second component carrier is the component carrier for the NR.

19. The wireless device of claim 14, wherein the power imbalance is determined from a differential RSRP value between the first RSRP and the second RSRP.

20. The wireless device of claim 14, wherein the at least one processor is further configured to execute the instructions stored in the memory to cause the wireless device to:
measure a plurality RSRPs for a plurality of available component carriers including the first component carrier and the second component carrier; and
report, to the network device, a maximum RSRP among the plurality of RSRPs and differential RSRP values between the maximum RSRP and other RSRPs of the plurality of RSRPs,
wherein the power imbalance between the first component carrier and the second component carrier is determined from the maximum RSRP and the differential RSRP values.

21-34. (canceled)
